(19) United States
(12) Patent Application Publication
(10) Pub. No.: US 2019/0292298 A1
(43) Pub. Date: Sep. 26, 2019

(54) METHOD FOR DELAYING CURING IN POLYURETHANE AND COMPOSITIONS AND ARTICLES MADE THEREFROM

(71) Applicant: ROGERS CORPORATION, Chandler, AZ (US)

(72) Inventors: Joseph Puglisi, Stafford Springs, CT (US); Kurt C. Frisch, JR., Woodstock, CT (US)

(21) Appl. No.: 16/342,682

(22) PCT Filed: Oct. 11, 2017
(86) PCT No.: PCT/US2017/056029

§ 371 Date: Apr. 17, 2019

Related U.S. Application Data
(60) Provisional application No. 62/409,131, filed on Oct. 17, 2016.

(51) Int. Cl. C08G 18/08; C08G 18/76; C08G 18/22

(52) U.S. Cl. CPC C08G 18/089; C08G 18/14; C08G 18/222; C08G 18/7671

(57) ABSTRACT

A method for the manufacture of a polyurethane includes forming a curable composition comprising an active hydrogen-containing component, an organic isocyanate component reactive with the active hydrogen-containing component, a metal catalyst, preferably a metal acetylacetonate, and a catalytic inhibitor effective to inhibit gelling of the curable composition for at least 4.7 minutes, preferably at least 5 minutes at a temperature of 55° C.; processing the curable composition at a first temperature without curing the curable composition; and curing the curable composition to provide the polyurethane.

### BACKGROUND

This disclosure relates generally to methods of making polyurethanes and the products produced by the methods. The methods are useful in the manufacture of solid polyurethanes and polyurethane foams and articles made therefrom.

Polyurethanes are generally formed from reactive mixtures that include polyurethane-forming components, in particular organic isocyanate components and active hydrogen-containing components that are substantially reactive with each other in the presence of a catalyst. Foamed polyurethanes can be made by frothing or blowing the reactive mixtures.

Several polyurethane processes of the prior art rely on the use of ferric acetylacetonate catalyst. One drawback associated with the use of ferric acetylacetonate as catalyst in polyurethane reactions is its high catalytic activity at room temperature which can result in undesirably rapid, i.e., premature, curing of the reactive mixtures. For example, if polyurethane curing is too rapid, it can occur during bulk material transport and processing, it can decrease or prevent material diffusion, or cause phase separation, to produce a foam of lower quality.

Accordingly, there remains a need for methods of delaying cure in polyurethanes having improved physical properties.

### SUMMARY

A method for the manufacture of a polyurethane comprises: forming a curable composition comprising an active hydrogen-containing component, an organic isocyanate component reactive with the active hydrogen-containing component, a metal catalyst, preferably a metal acetylacetonate, and a catalytic inhibitor effective to inhibit gelling of the curable composition for at least 4.7 minutes, preferably at least 5 minutes at a temperature of 55° C.; processing the curable composition at a first temperature without curing the curable composition; and curing the curable composition to provide the polyurethane.

Further described herein is a polyurethane made by the above-described methods, and articles comprising the polyurethanes.

The above described and other features are exemplified by the following FIGURES and Detailed Description.

### BRIEF DESCRIPTION OF THE DRAWINGS

The following FIGURE is an exemplary embodiment, and depicts the gel time for a curable urethane composition containing catalytic inhibitors in accordance with some embodiments of the disclosure.

### DETAILED DESCRIPTION

The inventors hereof have found methods that delay, i.e., inhibit, curing in curable urethane compositions. In general, these compositions include an active hydrogen-containing component, an organic isocyanate component reactive with the active hydrogen-containing component, optionally a surfactant, a metal catalyst, and a catalytic inhibitor. Usually, the metal catalyst includes a metal acetylacetonate. This catalyst can facilitate undesirably rapid, i.e., premature, curing in curable polyurethane-forming compositions, even at room temperature (i.e., 25° C.). In a key step of the disclosure, curing of curable urethane compositions can be delayed or premature curing can be avoided in the presence of a catalytic inhibitor. Advantageously, delayed curing of the curable urethane compositions allows for sufficient time for material transport and material diffusion during polyurethane manufacture. In a further advantage, delayed curing in the presence of a catalytic inhibitor results in polyurethanes, preferably foamed polyurethanes, with improved physical properties such as resistance to compression set. In a further advantage of the disclosure, curing of curable urethane compositions can be delayed at a temperature above room temperature, for example, a cure temperature above the melting point of the active hydrogen-containing component.

Without wishing to be bound by theory, it is believed that the catalytic inhibitor can be used to delay or inhibit the normally reactive catalysts, i.e., metal acetyl acetonates, at the higher temperatures needed to achieve proper mixing and casting of raw material that are solids at room temperature. In other words, the catalytic inhibitor provides heat latency which allows time for the required mixing, casting, and other procedures, and avoids deleterious premature curing during processing at temperatures above the melting point of raw materials.

The catalytic inhibitor usually includes a β-diketone having a boiling point above 150° C., a β-diketoamide, a β-ketoester, a β-diester, a β-dinitrile, a β-dialdehyde, a β-keto aldehyde, or a combination comprising at least one of the foregoing. Non-limiting examples of the catalytic inhibitor include acetylacetone, dibenzoylmethane, 4,4,4-trifluoro-1-phenyl-1,3-butanedione, N,N-diethyl-acetoacetamide, benzoylacetone, dimethyl isobutylmalonate, diethyl isobutylmalonate, 3-ethyl-2,4-pentanedione, 3-chloro-2,4-pentanedione, dimethyl malonate, diethyl malonate, malononitrile, 18-crown-6, or a combination comprising at least one of the foregoing. Preferably, the catalytic inhibitor includes dibenzoylmethane, 4,4,4-trifluoro-1-phenyl-1,3-butanedione, N,N-diethyl-acetoacetamide, or a combination comprising at least one of the foregoing.

The amount of catalytic inhibitor can be 5 to 5000 mole %, preferably 20 to 2000 mole %, more preferably 50 to 1000 mole %, more preferably still 100 to 1000 mole %, each based on total moles of metal catalyst, for example, metal acetylacetonate.

The organic isocyanate components generally include polyisocyanates having the general formula Q(NCO)ᵢ, wherein “i” is an integer having an average value of greater than two, and Q is an organic radical having a valence of “i”. Q can be a substituted or unsubstituted hydrocarbon group (e.g., an alkane or an aromatic group of the appropriate valency). Q can be a group having the formula Q¹-Z-Q¹ wherein Q¹ is an alkylene or arylene group and Z is —O—, —O-Q¹-S, —CO—, —S—, —S-Q¹-S—, —SO— or —SO₂—. Exemplary isocyanates include hexamethylene diisocyanate, 1,8-diisocyanato-p-methane, xylyl diisocyanate, diisocyanatocyclohexane, phenylene diisocyanates, toluene/tolylene diisocyanates, including 2,4-tolylene diisocyanate, 2,6-tolylene diisocyanate, and crude tolylene diisocyanate, bis(4-isocyanatophenyl)methane, chlorophenylene diisocyanates, diphenylmethane-4,4′-diisocyanate (also known as 4,4′-diphenyl methane diisocyanate, or MDI) and adducts thereof, naphthalene-1,5-diisocyanate, triphenylmethane-4,4′,4″-triisocyanate, isopropylbenzene-alpha-4-diisocyanate, polymeric isocyanates such as polymethylene polyphenylisocyanate, a prepolymer comprising at least one of the foregoing, a quasi-prepolymer comprising at least one of the foregoing, or combinations comprising at least one of the foregoing isocyanates.

Q can also represent a polyurethane group having a valence of “i”, in which case Q(NCO)ᵢ is a composition known as a prepolymer. Such prepolymers are formed by reacting a stoichiometric excess of a polyisocyanate as set forth herein with an active hydrogen-containing component, especially the polyhydroxyl-containing materials or polyols described below. Usually, for example, the polyisocyanate is used in proportions of 30 percent to 200 percent stoichiometric excess, the stoichiometry being based upon equivalents of isocyanate group per equivalent of hydroxyl in the polyol. The amount of polyisocyanate used will vary slightly depending upon the nature of the polyurethane being prepared.

The active hydrogen-containing component can comprise polyether polyols or polyester polyols. Exemplary polyester polyols are inclusive of polycondensation products of polyols with dicarboxylic acids or ester-forming derivatives thereof (such as anhydrides, esters and halides), polylactone polyols obtainable by ring-opening polymerization of lactones in the presence of polyols, polycarbonate polyols obtainable by reaction of carbonate diesters with polyols, and castor oil polyols. Exemplary dicarboxylic acids and derivatives of dicarboxylic acids which are useful for producing polycondensation polyester polyols are aliphatic or cycloaliphatic dicarboxylic acids such as glutaric, adipic, sebacic, fumaric and maleic acids; dimeric acids; aromatic dicarboxylic acids such as phthalic, isophthalic and terephthalic acids; tribasic or higher functional polycarboxylic acids such as pyromellitic acid; as well as anhydrides and second alkyl esters, such as maleic anhydride, phthalic anhydride and dimethyl terephthalate.

Additional active hydrogen-containing components are the polymers of cyclic esters. The preparation of cyclic ester polymers from at least one cyclic ester monomer is well documented in the patent literature as exemplified by U.S. Pat. Nos. 3,021,309 through 3,021,317; 3,169,945; and 2,962,524. Exemplary cyclic ester monomers include δ-valerolactone; ε-caprolactone; zeta-enantholactone; and the monoalkyl-valerolactones (e.g., the monomethyl-, monoethyl-, and monohexyl-valerolactones). In general the polyester polyol can comprise caprolactone based polyester polyols, aromatic polyester polyols, ethylene glycol adipate based polyols, and combinations comprising at least one of the foregoing polyester polyols, and especially polyester polyols made from ε-caprolactones, i.e. polycaprolactone, adipic acid, phthalic anhydride, terephthalic acid and/or dimethyl esters of terephthalic acid.

The polyether polyols are obtained by the chemical addition of alkylene oxides (such as ethylene oxide, propylene oxide, and so forth, as well as combinations comprising at least one of the foregoing), to water or polyhydric organic components (such as ethylene glycol, propylene glycol, trimethylene glycol, 1,2-butylene glycol, 1,3-butanediol, 1,4-butanediol, 1,5-pentanediol, 1,2-hexylene glycol, 1,10-decanediol, 1,2-cyclohexanediol, 2-butene-1,4-diol, 3-cyclohexene-1,1-dimethanol, 4-methyl-3-cyclohexene-1,1-dimethanol, 3-methylene-1,5-pentanediol, diethylene glycol, (2-hydroxyethoxy)-1-propanol, 4-(2-hydroxyethoxy)-1-butanol, 5-(2-hydroxypropoxy)-1-pentanol, 1-(2-hydroxymethoxy)-2-hexanol, 1-(2-hydroxypropoxy)-2-octanol, 3-allyloxy-1,5-pentanediol, 2-allyloxymethyl-2-methyl-1,3-propanediol, [4,4-pentyloxy)-methyl]-1,3-propanediol, 3-(o-propenylphenoxy)-1,2-propanediol, 2,2′-diisopropylidenebis(p-phenyleneoxy)diethanol, glycerol, 1,2,6-hexanetriol, 1,1,1-trimethylolethane, 1,1,1-trimethylolpropane, 3-(2-hydroxyethoxy)-1,2-propanediol, 3-(2-hydroxypropoxy)-1,2-propanediol, 2,4-dimethyl-2-(2-hydroxyethoxy)-methylpentanediol-1,5; 1,1,1-tris[2-hydroxyethoxy) methyl]-ethane, 1,1,1-tris[2-hydroxypropoxy)-methyl] propane, diethylene glycol, dipropylene glycol, pentaerythritol, sorbitol, sucrose, lactose, alpha-methylglucoside, alpha-hydroxyalkylglucoside, novolac resins, phosphoric acid, benzenephosphoric acid, polyphosphoric acids such as tripolyphosphoric acid and tetrapolyphosphoric acid, ternary condensation products, and so forth, as well as combinations comprising at least one of the foregoing). The alkylene oxides used in producing polyoxyalkylene polyols normally have 2 to 4 carbon atoms. Propylene oxide and mixtures of propylene oxide with ethylene oxide are preferred. The polyols listed above can be used per se as the active hydrogen component.

A useful class of polyether polyols is represented generally by the formula R[(OCHₙH₂ₙ)_{z}OH]ₐ wherein R is hydrogen or a polyvalent hydrocarbon radical; “a” is an integer equal to the valence of R, “n” in each occurrence is an integer of 2 to 4 inclusive (preferably 3), and “z” in each occurrence is an integer having a value of 2 to 200, or, more preferably, 15 to 100. Desirably, the polyether polyol comprises a mixture of one or more of dipropylene glycol, 1,4-butanediol, and 2-methyl-1,3-propanediol, and so forth.

Another type of active hydrogen-containing materials that can be used is polymer polyol compositions obtained by polymerizing ethylenically unsaturated monomers in a polyol as described in U.S. Pat. No. 3,383,351. Exemplary monomers for producing such compositions include acrylonitrile, vinyl chloride, styrene, butadiene, vinylidene chloride, and other ethylenically unsaturated monomers. The polymer polyol compositions can contain 1 weight percent (wt. %) to 70 wt. %, or, more preferably, 5 wt % to 50 wt %, and even more preferably, 10 wt % to 40 wt % monomer polymerized in the polyol, where the weight percent is based on the total weight of polyol. Such compositions are conveniently prepared by polymerizing the monomers in the selected polyol at a temperature of 40° C. to 150° C. in the presence of a free radical polymerization catalyst such as peroxides, persulfates, percarbonate, perborates, azo compounds, and combinations comprising at least one of the foregoing.

The active hydrogen-containing component can also contain polyhydroxyl-containing compounds, such as hydroxyl-terminated polyhydrocarbons (U.S. Pat. No. 2,877,212); hydroxyl-terminated polyformals (U.S. Pat. No. 2,870,097); fatty acid triglycerides (U.S. Pat. Nos. 2,833,730 and 2,878,601); hydroxyl-terminated polyesters (U.S. Pat. Nos. 2,698,838; 2,921,915; 2,591,884; 2,866,762; 2,850,476; 2,602,783; 2,729,618; 2,779,689; 2,811,493; 2,621,166 and 3,169,945); hydroxymethyl-terminated perfluoromethylenes (U.S. Pat. Nos. 2,911,390 and 2,902,473); hydroxyl-terminated polyalkylene ether glycols (U.S. Pat. No. 2,808,391; British Pat. No. 733,624); hydroxyl-terminated polyalkylenearylene ether glycols (U.S. Pat. No. 2,808,391); and hydroxyl-terminated polyalkylene ether triols (U.S. Pat. No. 2,866,774).

Chain extenders and crosslinking can be included in the active hydrogen-containing component. Exemplary chain extenders and crosslinking agents are low molecular weight diols, such as alkane diols and dialkylene glycols, and/or polyhydric alcohols, preferably triols and tetrols, having a molecular weight from 80 to 450. Examples of chain extenders include ethylene glycol, diethylene glycol, dipropylene glycol 1,4-butanediol, 1,6-hexanediol, cyclohexane dimethanol, hydroquinone bis(2-hydroxyethyl) ether, and the like. A combination comprising at least one of the foregoing can be used. The chain extenders and cross-linking agents can be used in amounts from 0.5 to 20 wt. %, preferably from 10 to 15 wt. %, based on the total weight of the polyol component.

In some embodiments, the prepolymer composition for producing a foam can be substantially in accordance with Japanese Patent Publication No. Sho 53-8735. The polyol desirably used has a repeated unit (referred to as “Unit”) of each of PO (propylene oxide) and/or PTMG (tetrahydrofuran subjected to ring-opening polymerization), or the like. In a specific embodiment, the amount of EO (ethylene oxide; (CH₂CH₂O)ₙ) is minimized in order to improve the hygroscopic properties of the foam. Preferably, the percentage of an EO Unit (or an EO Unit ratio) in a polyol can be less than or equal to 20%. For example, when a polyol to be used merely consists of a PO-Unit and an EO Unit, this polyol is set to be within the range of [the PO Unit]:[the EO Unit]=100:0 to 80:20. The percentage of an EO Unit is referred to as “EO content.” In some embodiments, the polyol component comprises one or a combination of an ethylene oxide capped polyether oxide diol having a molecular weight in the range from 2000 to 3500.

The polyols can have hydroxyl numbers that vary over a wide range. In general, the hydroxyl numbers of the polyols, including other cross-linking additives, if used, can be 28 to 1,000, and higher, or, more preferably, 100 to 800. The hydroxyl number is defined as the number of milligrams of potassium hydroxide required for the complete neutralization of the hydrolysis product of the fully acetylated derivative prepared from 1 gram of polyol or mixtures of polyols with or without other cross-linking additives. The hydroxyl number can also be defined by the equation:

$$OH = \frac{56.1 \times 1000 \times f}{{M}_{W}}$$

wherein: OH is the hydroxyl number of the polyol,
f is the average functionality, that is the average number of hydroxyl groups per molecule of polyol, and
M_{w} is the average molecular weight of the polyol.

In an embodiment, the catalytic inhibitor is added to the active hydrogen-containing component. In some instances, the catalytic inhibitor is dissolved in the active hydrogen-containing component, i.e., before the forming. Usually, the catalytic inhibitor is added before the processing.

The exact polyol or polyols employed depends upon the end-use of the polyurethane foam. In particular, variation in the polyol component can yield a wide range of moduli and toughness. The molecular weight and the hydroxyl number are selected properly to result in flexible foams. The polyol or polyols including cross-linking additives, if used, preferably possesses a hydroxyl number of from 28 to 1250 or more when employed in flexible foam formulations. Such limits are not intended to be restrictive, but are merely illustrative of the large number of possible combinations of the polyols that can be used.

A number of metal catalysts including metal acetylacetonate can be used. Exemplary catalysts include aluminum acetyl acetonate, barium acetyl acetonate, cadmium acetyl acetonate, calcium acetyl acetonate, cerium (III) acetyl acetonate, chromium (III) acetyl acetonate, cobalt (II) acetyl acetonate, cobalt (III) acetyl acetonate, copper (II) acetyl acetonate, indium acetyl acetonate, iron (II) acetyl acetonate, iron (III) acetyl acetonate, lanthanum acetylacetonate, lead (II) acetyl acetonate, manganese (II) acetyl acetonate, manganese (III) acetyl acetonate, neodymium acetyl acetonate, nickel (II) acetyl acetonate, palladium (II) acetyl acetonate, potassium acetyl acetonate, samarium acetyl acetonate, sodium acetyl acetonate, terbium acetyl acetonate, titanium (IV) acetyl acetonate, vanadium (V) acetyl acetonate, yttrium acetyl acetonate, zinc (II) acetyl acetonate, zirconium (IV) acetyl acetonate, or a combination comprising at least one of the foregoing, preferably iron (III) acetyl acetonate.

The amount of catalyst present can be 0.001 to 0.5 weight percent (wt. %), preferably 0.005 to 0.1 wt. %, more preferably 0.006 to 0.02 wt. %, based on weight of the curable composition.

If present, the molar ratio of metal catalyst, e.g., metal acetylacetonate, to catalytic inhibitor, for example, acetylacetone or dibenzoylmethane, is 5:1 to 1:20, preferably 3:1 to 1:10, more preferably 1:1 to 1:10, more preferably still 1:3 to 1:6, on a molar basis. In an embodiment, the molar ratio of metal acetyl acetonate to catalytic inhibitor is 1:6.

If a foam is formed, a wide variety of surfactants can be used for purposes of stabilizing the polyurethane foam before it is cured, including mixtures of surfactants. Organosilicone surfactants are especially useful, such as a copolymer consisting essentially of SiO₂ (silicate) units and (CH₃)₃SiO_{0.5} (trimethylsiloxy) units in a molar ratio of silicate to trimethylsiloxy units of 0.8:1 to 2.2:1, or, more preferably, 1:1 to 2.0:1. Another organosilicone surfactant stabilizer is a partially cross-linked siloxane-polyoxyalkylene block copolymer and mixtures thereof wherein the siloxane blocks and polyoxyalkylene blocks are linked by silicon to carbon, or by silicon to oxygen to carbon, linkages. The siloxane blocks comprise hydrocarbon-siloxane groups and have an average of at least two valences of silicon per block combined in the linkages. At least a portion of the polyoxyalkylene blocks comprise oxyalkylene groups and are polyvalent, i.e., have at least two valences of carbon and/or carbon-bonded oxygen per block combined in said linkages. Any remaining polyoxyalkylene blocks comprise oxyalkylene groups and are monovalent, i.e., have only one valence of carbon or carbon-bonded oxygen per block combined in said linkages. Additional organopolysiloxane-polyoxyalkylene block copolymers include those described in U.S. Pat. Nos. 2,834,748, 2,846,458, 2,868,824, 2,917,480 and 3,057,901. Combinations comprising at least one of the foregoing surfactants can also be used. The amount of the organosilicone polymer used as a foam stabilizer can vary over wide limits, e.g., 0.5 wt % to 10 wt % or more, based on the amount of the active hydrogen component, or, more preferably, 1.0 to 6.0 wt. %.

The curable compositions can further comprise one or more other components or additives, such as flame retardants, fillers, inhibitors, dispersing aids, adhesion promotors, dyes, plasticizers, heat stabilizers, pigments, antioxidants, epoxy compounds, or a combination comprising at least one of the foregoing. Usually, the amount of the additive used is, based on total weight of polyurethane composition, 0.5 to 40 wt. %, preferably 5 to 40 wt. %, more preferably 10 to 30 wt. %.

Examples of flame retardants include graphite-containing flame retardants, phosphorus-containing flame retardants, halogen-containing flame retardants, for example aromatic brominated or chlorinated flame retardants, or a combination comprising at least one of the foregoing. Examples of specific flame retardants include tribromoneopentyl alcohol, tris(2-chloroisopropyl)phosphate, tris(dichloropropyl)phosphate, chlorinated alkyl phosphate ester, a halogenated aryl ester/aromatic phosphate blend, pentabromobenzyl alkyl ethers, brominated epoxies, alkylated triphenyl phosphate esters, or a combination comprising at least one of the foregoing.

Processing the curable composition is at a first temperature, and is without curing the curable composition. Usually, processing the curable composition is at a first temperature of up to 120° C., preferably 40 to 120° C., more preferably 50 to 120° C. In some instances, the processing includes transferring the curable composition, shaping the curable composition, or a combination comprising at least one of the foregoing.

The curing occurs over a cure time. Usually, this cure time is at least 50% longer than a cure time of an otherwise identical curable composition but without the catalytic inhibitor, as determined by gel time testing at 70° C. Preferably, the cure time according to gel time testing at 70° C. is at least 100% longer, more preferably at least 200% longer, than a cure time of an otherwise identical curable composition but without the catalytic inhibitor, also as determined by gel time testing at 70° C. In some instance, the cure time is greater than 2 minutes, preferably greater than 3 minutes, more preferably greater than 5 minutes, as determined by gel time testing at 70° C.

The curing can be at a temperature equal to or greater than room temperature. Temperatures greater than room temperature can be suitably selected if the melting point of the urethane compositions is greater than room temperature. For example, the curing temperature can be 30 to 100° C. or 40 to 80° C. or 55 to 70° C. In an embodiment, the curing is at a temperature where the active-hydrogen-containing component is in the molten state, i.e., at or above the melting point of the active-hydrogen-containing component. In some embodiments, a curing temperature of 30 to 100° C. can result from shear while mixing the components in a high shear mixer.

In some embodiments, the curing includes raising the temperature of the curable composition to a second temperature effective to cure the curable composition. In these instances, the second temperature can be 40 to 120° C., preferably 60 to 120° C., more preferably 60 to 120° C.

In some instances, the catalytic inhibitor is effective to inhibit gelling of the curable composition for at least two minutes, preferably at least three minutes, at a temperature of 70° C. In some embodiments, the inhibitor is effective to provide a gel time at 70° C. that is 3 times longer, preferably at least 3.5 times longer, more preferably at least 4 times longer, than a gel time of an otherwise identical curable composition but without the catalytic inhibitor.

The polyurethane composition can be a polyurethane foam. As used herein, “foam” refers to material having a cellular or porous structure. “Cellular foams” refers to materials where at least a portion of the cells extends through the layer. Suitable foams have densities lower than 65 pounds per cubic foot (lb/ft³, pcf), preferably less than or equal to 55 pcf, more preferably less than or equal to 52 pcf, for example 5 to 52 pcf. The foams can have a void volume content of 13-99%, preferably greater than or equal to 30%, based upon the total volume of the polymeric foam. In some embodiments, the foam has a density of 5 to 30 pcf (80 to 481 kg/m³), a 25% compression force deflection (CFD) 0.5 to 450 lb/in² (0.003 to 3.10 N/mm²), and a compression set at 158° F. (70° C.) of less than 10% and at 70° F. (21° C.) of less than 10%, preferably less than 5%.

A polyurethane foam can be manufactured by mechanically frothing or chemically or physically blowing, or a combination comprising at least one of the foregoing. For example, the curable composition can be mechanically frothed, then formed into a shape, for example a sheet, followed by curing. In an embodiment, the polyurethane foam is a frothed or water-blown foam. Preferably, the foam is a mechanically frothed foam.

Any mechanically frothed polyurethane composition forming curable composition can be used in the practice of the methods. Reference is particularly made to U.S. Pat. Nos. 3,706,681; 3,755,212; 3,772,224; 3,821,130; 3,862,879; 3,947,386; 4,022,722; 4,216,177 and 4,692,476 for disclosures of mechanically frothed polyurethane forming mixtures and components (e.g., surfactant) which are particularly suitable for use, which United States patents are incorporated herein by reference in their entirety. It will also be understood that any other mechanically frothed polyurethane-forming mixture can be used.

As discussed in detail in U.S. Pat. No. 4,216,177, the mechanically frothed polyurethane forming mixture is formed by mechanically beating an inert gas, such as air, into the mixture in standard mixing equipment such as an SKG mixer, Hobart mixer or an Oakes mixer. The mixture is thus mechanically frothed, to form a froth that is substantially chemically stable and is structurally stable but easily workable at ambient temperatures between 15° C. and 30° C. The consistency of this froth can resemble that of aerosol-dispensed shaving cream. In an embodiment, the froth is easily workable at temperatures of 70 to 100° C.

When the foams are blown, a wide variety of blowing agents can be used in the prepolymer compositions, including chemical or physical blowing agents. Chemical blowing agents include, for example, water, and chemical compounds that decompose with a high gas yield under specified conditions, for example within a narrow temperature range. Desirably, the decomposition products do not effloresce or have a discoloring effect on the foam product. Exemplary chemical blowing agents include water, azoisobutyronitrile, azodicarbonamide (i.e. azo-bis-formamide) and barium azodicarboxylate; substituted hydrazines (e.g., diphenylsulfone-3,3′-disulfohydrazide, 4,4′-hydroxy-bis-(benzenesulfohydrazide), trihydrazinotriazine, and aryl-bis-(sulfohydrazide)); semicarbazides (e.g., p-tolylene sulfonyl semicarbazide an d4,4′-hydroxy-bis-(benzenesulfonyl semicarbazide)); triazoles (e.g., 5-morpholyl-1,2,3,4-thiatriazole); N-nitroso compounds (e.g., N,N′-dinitrosopentamethylene tetramine and N,N-dimethyl-N,N′-dinitrosophthalmide); benzoxazines (e.g., isatoic anhydride); as well as combinations comprising at least one of the foregoing, such as, sodium carbonate/citric acid mixtures.

The amount of chemical blowing agents can vary depending on the agent and the desired foam density. In general, chemical blowing agents can be used in an amount of 0.1 to 10 wt. %, based upon a total weight of the prepolymer composition. When water is used as a blowing agent (e.g., in an amount of 0.1 to 8 wt. % based upon the total weight of prepolymer composition), it is generally desirable to control the curing reaction by selectively employing catalysts.

Physical blowing agents can also (or alternatively) be used. These blowing agents can be selected from a broad range of materials, including hydrocarbons, ethers, esters, (including partially halogenated hydrocarbons, ethers, and esters), and so forth, as well as combinations comprising at least one of the foregoing. Exemplary physical blowing agents include the CFC's (chlorofluorocarbons) such as 1,1-dichloro-1-fluoroethane, 1,1-dichloro-2,2,2-trifluoro-ethane, monochlorodifluoromethane, and 1-chloro-1,1-difluoroethane; the FC's (fluorocarbons) such as 1,1,1,3,3,3-hexafluoropropane, 2,2,4,4-tetrafluorobutane, 1,1,1,3,3,3-hexafluoro-2-methylpropane, 1,1,1,3,3-pentafluoropropane, 1,1,1,2,2-pentafluoropropane, 1,1,1,2,3-pentafluoropropane, 1,1,2,3,3-pentafluoropropane, 1,1,2,2,3-pentafluoropropane, 1,1,1,3,3,4-hexafluorobutane, 1,1,1,3,3-pentafluorobutane, 1,1,1,4,4,4-hexafluorobutane, 1,1,1,4,4-pentafluorobutane, 1,1,2,2,3,3-hexafluoropropane, 1,1,1,2,3,3-hexafluoropropane, 1,1-difluoroethane, 1,1,1,2-tetrafluoroethane, and pentafluoroethane; the FE's (fluoroethers) such as methyl-1,1,1-trifluoroethylether and difluoromethyl-1,1,1-trifluoroethylether; hydrocarbons such as n-pentane, isopentane, and cyclopentane; and well as combinations comprising at least one of the foregoing. As with the chemical blowing agents, the physical blowing agents are used in an amount sufficient to give the resultant foam the desired bulk density. The physical blowing agents can be used in an amount of 5 to 50 wt. % of the prepolymer composition, or, more preferably, 10 to 30 wt. % of the prepolymer composition.

After frothing or blowing, the composition (referred to as a “froth” for convenience) is then transferred at a controlled rate through a hose or other conduit to be deposited onto a moving support. The support can have either have a plain surface or a textured surface onto which the foam is deposited. The support can be played out from a supply roll and pulled by rolls to pass by various stations in the system, and, generally, can be ultimately rewound on a take-up roll. The support can be a release substrate, e.g., a release paper, a thin sheet of metal such as stainless steel, or a polymer or other material. The support can have a release coating or be coated with a material such as a urethane film that transfers to the surface of the foam. If desired, the support material can be a substrate of fibrous or other material that becomes laminated to and forms part of the final product instead of being separated from the foam and being rewound on a take-up roll. Alternatively, the release support can also be a conveyor belt.

As the support is moved with the foam deposited thereon, the foam can be spread to a layer of desired thickness by a doctoring blade or other suitable spreading device. A simple knife over table doctoring blade or other more complex spreading devices such as a knife over roller coaters or three or four roll reversible coaters can be used. The doctoring blade can spread the material to the desired thickness, for example a thickness of 0.01 to 100 mm.

The assembly of the release support and the gauged layer of foam is then delivered to a heating zone which consists of spaced apart lower and upper heating platens. The platens may be parallel and have an equidistant spacing therebetween along their entire lengths, or they can be slightly diverging from the entrance to the exit. The heating platens are heated by electric heating elements which may be separately controlled to provide incremental heating. The platens may be simple platens or each may be made up of two or more separate platens, any of which may have separate electrical heating elements to provide zones of different temperatures.

As the assembly of release paper and the gauged layer of frothed material passes through the heat zone between the platens, there is direct conduction heating of the froth layer from the lower platen which is in direct contact with release paper. In addition, the upper heating platen may be spaced as close as desired above the upper surface of the frothed layer as long as it does not contact the uncovered upper layer of the material and thus provides a substantially amount of radiant heating as well as some convection heating to the froth sheet. During this heating step, the froth material is cured by the promotion of polymerization whereby a cured polyurethane foam is produced. The temperatures of the platens are maintained in a range from 90° C. to 230° C. depending on the composition of the foam material. These platens may be maintained at equal or unequal temperatures depending on the particular nature of the curing process desired to be effected. For example, differential temperatures can be established for purposes of forming an integral skin on one layer of the foam or for laminating a relatively heavy layer to the foam.

After the assembly is heated, it can then be passed to a cooling zone where it is cooled by any suitable cooling device such as fans. The release paper can be removed and the foam taken up on a roll for storage or used as desired. The polyurethane foam product produced by the process described will be a foam sheet of uniform gauge. The density of the finished product is also relatively uniform because the conduction and radiant heating during the curing process provides for relatively even heat distribution across the foam sheet.

In an embodiment, the polyurethane foam has one or more of the following properties: a density of 40 to 900 kg/m³, preferably 100 to 850 kg/m³; a 25% compression force deflection of 0.5 to 450 lb/in² (0.003 to 3.10 N/mm²)), measured in accordance with ASTM 3574; a compression set at 158° F. (70° C.) of less than 10% and at 70° F. (21° C.) of less than 10%, preferably less than 5%, measured in accordance with ASTM 3574.

The curable compositions can also be formed into an article, for example by casting, extrusion, molding, blow-molding, or the like. It is preferred that this forming is by casting or molding. The articles can be any normally employing a polyurethane, for example gaskets, protective packaging, thermal insulation, gel pads, print rollers, electronic parts, straps, bands, autos, furniture, bedding, carpet underlay, shoe inserts, fabric coatings, and the like.

The invention is further illustrated by the following examples.

### EXAMPLES

The formulation shown in Table 1 was used as an exemplary curable composition for forming a polyurethane, and is based on formulations shown in US 2002/01282420, U.S. Pat. Nos. 6,559,196, and 6,635,688. The catalyst in each formulation was ferric acetylacetonate, which was provided with free acetylacetonate in a molar ratio of acetylacetonate to catalyst of 3:1. Apart from a control with no additional cure inhibitor, each example contained in addition a cure inhibitor in the amount shown. All catalyst inhibitors were added to provide 1.32×10⁻⁶ moles of inhibitor.

TABLE 1
Polyurethane formulations

| | Parts by weight |
|---|---|
| Formulation component | |
| Active hydrogen-containing component | 101.99 |
| Antioxidant | 0.5 |
| Ferric Acetylacetonate + | 0.075 |
| Acetyl acetone* | 0.066 |
| MDI isocyanate prepolymer | 50.0 |
| Cure inhibitor component | |
| Acetylacetone (AA) | 0.066 |
| Dibenzoyl methane (DBM) | 0.148 |
| 4,4,4-Trifluoro-1-phenyl-1,3-butanedione (TPB) | 0.143 |
| Dimethyl malonate (DMM) | 0.087 |

*Provided together in the listed amounts.

Each example was tested to determine gel time at 55° C. and 70° C. as follows. All raw materials were mixed and stored at the desired testing temperature. In particular, all raw materials except the isocyanate were mixed and placed in a 400 mL Flack Tek speed mixer beaker with screw top. The isocyanate was accurately measured out and added to the beaker rapidly by syringe. The beaker was quickly placed in the mixing chamber of the Flack Tek and mixed at 1250 rpm for 6 seconds, then 2100 rpm for 6 seconds, and finally 2500 rpm for 12 seconds. Upon completion of mixing, a timer was started and the contents of the beaker were poured into the testing cup of a Gardner Co. gel time tester with the cup temperature set to match the desired reaction temperature. The gel timer was switched on and allowed to spin until it reached its stopping point, at which moment the stop watch was also stopped to record the overall gel time of the system. All mixing times and transfer times were kept as consistent as possible.

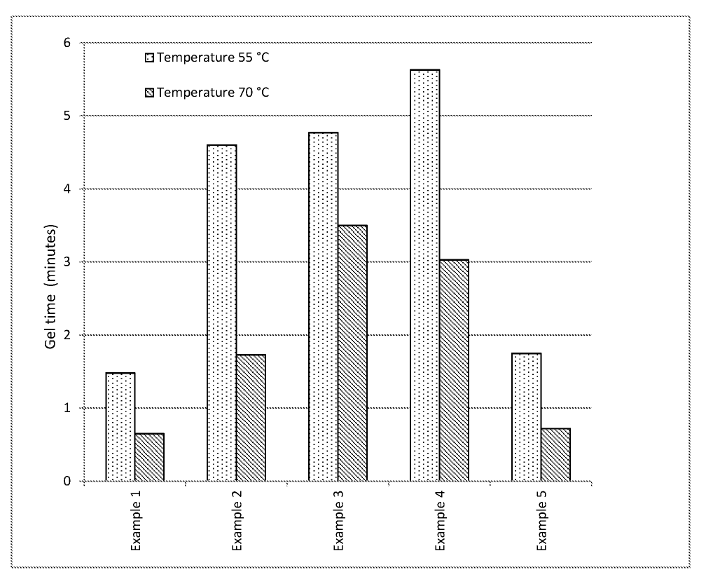

The results from gel time testing are summarized in Table 2 and depicted graphically in FIG. 1.

TABLE 2

Time to Gel (minutes)

| Example | Additional Cure inhibitor | at 55° C. | at 70° C. |
|---|---|---|---|
| 1 | None | 1.48 | 0.65 |
| 2 | AA | 4.60 | 1.73 |
| 3 | DBM | 4.77 | 3.5 |
| 4 | TPB | 5.63 | 3.03 |
| 5 | DMM | 1.75 | 0.72 |

The results in Table 2 and FIG. 1 show that gel time decreases with increasing temperature. Use of acetylacetone as a cure inhibitor increased gel time significantly over no added inhibitor or a compound such as dimethyl malonate at 55° C. The gel times using DBM and TPB as inhibitors were even further improved.

However, at 70° C., the gel time for acetylacetonate was on the same order as using no cure inhibitor at 55° C. These fast gel times indicate that acetylacetone is substantially less effective as a cure inhibitor at higher temperatures. The gel times of DBM and TPB, in contrast, indicate that these inhibitors are effective at higher processing temperatures.

The invention is further illustrated by the following embodiments.

Embodiment 1: A method for the manufacture of a polyurethane, the method comprising: forming a curable composition comprising an active hydrogen-containing component, an organic isocyanate component reactive with the active hydrogen-containing component, a metal catalyst, preferably a metal acetylacetonate, and a catalytic inhibitor effective to inhibit gelling of the curable composition for at least 4.7 minutes, preferably at least 5 minutes at a temperature of 55° C.; processing the curable composition at a first temperature without curing the curable composition; and curing the curable composition to provide the polyurethane.

Embodiment 2: The method of embodiment 1, wherein the catalytic inhibitor is effective to inhibit gelling of the curable composition for at least two minutes, preferably at least three minutes, at a temperature of 70° C.

Embodiment 3: The method of any one or more of embodiments 1 to 2, wherein the inhibitor is effective to provide a gel time at 70° C. that is 3 times longer, preferably at least 3.5 times longer, more preferably at least 4 times longer, than a gel time of an otherwise identical curable composition but without the catalytic inhibitor.

Embodiment 4: The method of any one or more of embodiments 1 to 3, wherein the processing the curable composition is at a first temperature of up to 120° C., preferably 40 to 120° C., more preferably 50 to 120° C.

Embodiment 5: The method of any one or more of embodiments 1 to 4, wherein the processing the curable composition comprises transferring the curable composition, shaping the curable composition, or a combination comprising at least one of the foregoing.

Embodiment 6: The method of any one or more of embodiments 1 to 5, wherein the curing comprises raising the temperature of the curable composition to a second temperature effective to cure the curable composition.

Embodiment 7: The method of any one or more of embodiments 1 to 3, wherein the curing the curable composition is at a second temperature of 40 to 120° C., preferably 60 to 120° C., more preferably 60 to 120° C.

Embodiment 8: The method of embodiment 1, wherein the curable composition further comprises a surfactant, and the method further comprises frothing, physically blowing, or chemically blowing the curable composition, or a combination comprising at least one of the foregoing, to provide a polyurethane foam, preferably mechanically frothing the polyurethane foam.

Embodiment 9: The method of any one or more of embodiments 1 to 8, wherein the catalytic inhibitor comprises a β-diketone having a boiling point above 150° C., a β-diketoamide, a β-keto ester, a β-diester, a β-dinitrile, β-dialdehyde, a β-keto aldehyde, a crown ether, or a combination comprising at least one of the foregoing.

Embodiment 10: The method of embodiment 9, wherein the catalytic inhibitor comprises dibenzoylmethane, 4,4,4-trifluoro-1-phenyl-1,3-butanedione, N,N-diethyl-acetoacetamide, benzoylacetone, dimethyl isobutylmalonate, diethyl isobutylmalonate, 3-ethyl-2,4-pentanedione, 3-chloro-2,4-pentanedione, malononitrile, 18-crown-6, or a combination comprising at least one of the foregoing, preferably wherein the catalytic inhibitor comprises dibenzoylmethane, 4,4,4-trifluoro-1-phenyl-1,3-butanedione, N,N-diethyl-acetoacetamide, or a combination comprising at least one of the foregoing.

Embodiment 11: The method of any one or more of embodiments 1 to 10, wherein the amount of the catalytic inhibitor is 5 to 5000 mole %, preferably 20 to 2000 mole %, more preferably 50 to 1000 mole %, more preferably still 100 to 1000 mole %, each based on total moles of metal catalyst, preferably metal acetylacetonate.

Embodiment 12: The method of any one or more of embodiments 1 to 11, wherein the active hydrogen-containing component comprises a polyester polyol, a polyether polyol, a polycaprolactone, or a combination comprising at least one of the foregoing, and a chain extender, preferably an ethylene glycol, diethylene glycol, dipropylene glycol 1,4-butanediol, 1,6-hexanediol, cyclohexane dimethanol, hydroquinone bis(2-hydroxyethyl) ether, or a combination comprising at least one of the foregoing.

Embodiment 13: The method of any one or more of embodiments 1 to 12, wherein the organic isocyanate component comprises diphenylmethane-4,4′-diisocyanate, toluene diisocyanate, a prepolymer comprising at least one of the foregoing, a quasi-prepolymer comprising at least one of the foregoing, or a combination comprising at least one of the foregoing.

Embodiment 14: The method of any one or more of embodiments 1 to 13, wherein the metal catalyst comprises aluminum acetylacetonate, barium acetylacetonate, cadmium acetylacetonate, calcium acetylacetonate, cerium (III) acetylacetonate, chromium (III) acetylacetonate, cobalt (II) acetylacetonate, cobalt (III) acetylacetonate, copper (II) acetylacetonate, indium acetylacetonate, iron (II) acetylacetonate, iron (III) acetylacetonate, lanthanum acetylacetonate, lead (II) acetylacetonate, manganese (II) acetylacetonate, manganese (III) acetylacetonate, neodymium acetylacetonate, nickel (II) acetylacetonate, palladium (II) acetylacetonate, potassium acetylacetonate, samarium acetylacetonate, sodium acetylacetonate, terbium acetylacetonate, titanium acetylacetonate, vanadium acetylacetonate, yttrium acetylacetonate, zinc acetylacetonate, zirconium acetylacetonate, or a combination comprising at least one of the foregoing, preferably iron (III) acetylacetonate.

Embodiment 15: The method of any one or more of embodiments 1 to 14, wherein the metal catalyst comprises acetyl acetone.

Embodiment 16: A polyurethane made by the method of any one or more of embodiments 1 to 15.

Embodiment 17: The polyurethane of embodiment 16, wherein the composition comprises a frothed, water-blown, or physically blown polyurethane foam, preferably a mechanically frothed, water blown, or a combination of frothed and water blown polyurethane foam.

In general, the articles and methods described here can alternatively comprise, consist of, or consist essentially of, any components or steps herein disclosed. The articles and methods can additionally, or alternatively, be manufactured or conducted so as to be devoid, or substantially free, of any ingredients, steps, or components not necessary to the achievement of the function or objectives of the present claims.

The singular forms “a,” “an,” and “the” include plural referents unless the context clearly dictates otherwise. “Or” means “and/or.” Unless defined otherwise, technical and scientific terms used herein have the same meaning as is commonly understood by one of skill in the art to which this invention belongs. A “combination” is inclusive of blends, mixtures, alloys, reaction products, and the like. The values described herein are inclusive of an acceptable error range for the particular value as determined by one of ordinary skill in the art, which will depend in part on how the value is measured or determined, i.e., the limitations of the measurement system. The endpoints of all ranges directed to the same component or property are inclusive and independently combinable (e.g., ranges of “5 to 20 wt %” is inclusive of the endpoints and all intermediate values of the ranges of “5 to 25 wt %”). Disclosure of a narrower range or more specific group in addition to a broader range is not a disclaimer of the broader range or larger group.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While the disclosed subject matter is described herein in terms of some embodiments and representative examples, those skilled in the art will recognize that various modifications and improvements can be made to the disclosed subject matter without departing from the scope thereof. Additional features known in the art likewise can be incorporated. Moreover, although individual features of some embodiments of the disclosed subject matter can be discussed herein and not in other embodiments, it should be apparent that individual features of some embodiments can be combined with one or more features of another embodiment or features from a plurality of embodiments.

1. A method for the manufacture of a polyurethane, the method comprising:
forming a curable composition comprising an active hydrogen-containing component, an organic isocyanate component reactive with the active hydrogen-containing component, a metal catalyst, and a catalytic inhibitor effective to inhibit gelling of the curable composition for at least 4.7 minutes, at a temperature of 55° C.;
processing the curable composition at a first temperature without curing the curable composition; and
curing the curable composition to provide the polyurethane.

2. The method of claim 1, wherein the catalytic inhibitor is effective to inhibit gelling of the curable composition for at least two minutes, at a temperature of 70° C.

3. The method of claim 1, wherein the inhibitor is effective to provide a gel time at 70° C. that is 3 times longer, than a gel time of an otherwise identical curable composition but without the catalytic inhibitor.

4. The method of claim 1, wherein the processing the curable composition is at a first temperature of up to 120° C.

5. The method of claim 1, wherein the processing the curable composition comprises transferring the curable composition, shaping the curable composition, or a combination comprising at least one of the foregoing.

6. The method of claim 1, wherein the curing comprises raising the temperature of the curable composition to a second temperature effective to cure the curable composition.

7. The method of claim 1, wherein the curing the curable composition is at a second temperature of 40 to 120° C.

8. The method of claim 1, wherein the curable composition further comprises a surfactant, and the method further comprises frothing, physically blowing, or chemically blowing the curable composition, or a combination comprising at least one of the foregoing, to provide a polyurethane foam.

9. The method of claim 1, wherein the catalytic inhibitor comprises a β-diketone having a boiling point above 150° C., a β-diketoamide, a β-keto ester, a β-diester, a β-dinitrile, β-dialdehyde, a β-keto aldehyde, a crown ether, or a combination comprising at least one of the foregoing.

10. The method of claim 9, wherein the catalytic inhibitor comprises dibenzoylmethane, 4,4,4-trifluoro-1-phenyl-1,3-butanedione, N,N-diethyl-acetoacetamide, benzoylacetone, dimethyl isobutylmalonate, diethyl isobutylmalonate, 3-ethyl-2,4-pentanedione, 3-chloro-2,4-pentanedione, malononitrile, 18-crown-6, or a combination comprising at least one of the foregoing.

11. The method of claim 1, wherein the amount of the catalytic inhibitor is 5 to 5000 mole %, each based on total moles of metal catalyst.

12. The method of claim 1, wherein the active hydrogen-containing component comprises a polyester polyol, a polyether polyol, a polycaprolactone, or a combination comprising at least one of the foregoing, and a chain extender.

13. The method of claim 1, wherein the organic isocyanate component comprises diphenylmethane-4,4′-diisocyanate, toluene diisocyanate, a prepolymer comprising at least one of the foregoing, a quasi-prepolymer comprising at least one of the foregoing, or a combination comprising at least one of the foregoing.

14. The method of claim 1, wherein the metal catalyst comprises:
aluminum acetylacetonate, barium acetylacetonate, cadmium acetylacetonate, calcium acetylacetonate, cerium (III) acetylacetonate, chromium (III) acetylacetonate, cobalt (II) acetylacetonate, cobalt (III) acetylacetonate, copper (II) acetylacetonate, indium acetylacetonate, iron (II) acetylacetonate, iron (III) acetylacetonate, lanthanum acetylacetonate, lead (II) acetylacetonate, manganese (II) acetylacetonate, manganese (III) acetylacetonate, neodymium acetylacetonate, nickel (II) acetylacetonate, palladium (II) acetylacetonate, potassium acetylacetonate, samarium acetylacetonate, sodium acetylacetonate, terbium acetylacetonate, titanium acetylacetonate, vanadium acetylacetonate, yttrium acetylacetonate, zinc acetylacetonate, zirconium acetylacetonate, or a combination comprising at least one of the foregoing.

15. The method of claim 1, wherein the metal catalyst comprises iron (III) acetylacetonate.

16. A polyurethane made by the method of claim 1.

17. The polyurethane of claim 16, wherein the composition comprises a frothed, water-blown, or physically blown polyurethane foam.
